(19) United States
(12) Patent Application Publication
(10) Pub. No.: US 2026/0307369 A1
(43) Pub. Date: Oct. 8, 2026

(54) METALLIZED LAMINATE MATERIAL WITH SUPERIOR BARRIER PERFORMANCE

(71) Applicant: Dow Global Technologies LLC, Midland, MI (US)

(72) Inventors: Gang Wang, Jiangsu (CN); Shijun Wang, Anhui (CN); Chen Yan Bai, Shanghai (CN); Zhe Du, Zhejiang (CN); Xiaobing Yun, Beijing (CN); Jianping Pan, Shanghai (CN); Gaobing Chen, Shanghai (CN); Bo Xu, Shanghai (CN); Jianliang Zhu, Shanghai (CN)

(73) Assignee: Dow Global Technologies LLC, Midland, MI (US)

(21) Appl. No.: 19/481,356

(22) PCT Filed: May 8, 2023
(86) PCT No.: PCT/CN2023/092677

§ 371 Date: Nov. 4, 2025

(51) Int. Cl. B32B 27/08; B32B 27/32; B32B 37/12

(52) U.S. Cl. CPC B32B 27/08; B32B 27/32; B32B 37/12; B32B 2250/02; B32B 2250/242; B32B 2255/10; B32B 2255/205; B32B 2323/04

(57) ABSTRACT

Embodiments of a laminate material comprise: a first substrate comprising a first polyethylene (PE)-based film and a first metalized layer disposed on at least one surface of the first PE-based film; a second substrate comprising a second PE-based film and a second metalized layer disposed on at least one surface of the second PE-based film; and an adhesive layer adhering the first substrate to the second substrate, the adhesive layer disposed between the first and second metalized layers, wherein the laminate material has greater than 90 wt. % PE based on the total weight of the laminate material. Further embodiments are directed to articles comprising the laminate materials and methods of making the laminate material.

### TECHNICAL FIELD

The present disclosure relates to a laminate material, an article comprising the laminate material and a method for preparing the laminate material. The laminate material exhibits superior barrier performance.

### BACKGROUND

With the megatrend of recyclable economy, all polyethylene (PE) packages are more and more popular in industry. Barrier performance, e.g., oxygen transmission rate (OTR) and moisture vapor transmission (WVTR), are key attributes of various packages to provide crucial protection to the contents from an exterior circumstance to ensure a longer shelf life. However, due to the inherent inferior oxygen barrier of PE, it can be difficult to meet relevant high barrier needs using virgin PE design. Therefore, in the industry, there are various approaches to acquire the barrier performance, e.g., incorporating polymeric barrier resin through co-extrusion, vacuum metallization on a film substrate, or coating barrier materials on a film surface, etc. However, it is still a challenge in the packaging industry to achieve high barrier performance of recyclable full PE structures in terms of OTR.

For the above reasons, there is still a need in the packaging industry to develop a recyclable all PE package with superior barrier performance.

### SUMMARY

Embodiments of the present disclosure address these needs for an all PE laminate material with superior barrier performance, which can be used in packages.

In a first aspect of the present disclosure, the present disclosure provides a laminate material comprising a first substrate comprising a first polyethylene (PE)-based film and a first metalized layer disposed on at least one surface of the first PE-based film, a second substrate comprising a second PE-based film and a second metalized layer disposed on at least one surface of the second PE-based film, and an adhesive layer adhering the first substrate to the second substrate, the adhesive layer disposed between the first and second metalized layers, wherein the laminate material has greater than 90 wt. % PE based on the total weight of the laminate material.

These and additional features provided by the embodiments of the present disclosure will be more fully understood in view of the following detailed description.

### DETAILED DESCRIPTION

### Definitions

The term “polymer” refers to polymeric compounds prepared by polymerizing monomers, whether of the same or a different type. Accordingly, the generic term polymer includes homopolymers, which are polymers prepared by polymerizing only one monomer, and copolymers, which are polymers prepared by polymerizing two or more different monomers.

The term “interpolymer” refers to polymers prepared by polymerizing at least two different types of monomers. Accordingly, the generic term interpolymer includes copolymers and other polymers prepared by polymerizing more than two different monomers, such as terpolymers.

The terms “polyolefin,” “polyolefin polymer,” and “polyolefin resin” refer to polymers prepared by polymerizing a simple olefin (also referred to as an alkene, which has the general formula CₙH₂ₙ) monomer. Accordingly, the generic term polyolefin includes polymers prepared by polymerizing ethylene monomer with or without one or more comonomers, such as polyethylene, and polymers prepared by polymerizing propylene monomer with or without one or more comonomers, such as polypropylene.

The terms “polyethylene” and “ethylene-based polymer” refer to polyolefins comprising greater than 50 percent (%) by mole of units that have been derived from ethylene monomer, which includes polyethylene homopolymers and copolymers. Common forms of polyethylene known in the art include Low Density Polyethylene (LDPE), Linear Low Density Polyethylene (LLDPE), Ultra Low Density Polyethylene (ULDPE), Very Low Density Polyethylene (VLDPE), Medium Density Polyethylene (MDPE), and High Density Polyethylene (HDPE).

The term “melt flow ratio” refers to a ratio of melt indices of a polymer. Accordingly, the generic term melt flow ratio includes a ratio of a high load metal index (121) of a polymer to a melt index (I₂) of the polymer, which may also be referred to as an “MFR₂₁.”

The term “composition” refers to a mixture of materials that comprises the composition, as well as reaction products and decomposition products formed from the materials of the composition.

The terms “comprising,” “including,” “having,” and their derivatives, are not intended to exclude the presence of any additional component, step, or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step, or procedure, excepting those that are not essential to operability. The term “consisting of” excludes any component, step, or procedure not specifically delineated or listed.

“Polyethylene”, “polyethylene polymer”, “polyethylene-based”, “PE-based” or “ethylene-based polymer” shall mean polymers comprising a majority amount (>50 mol %, or >60 mol %, or >70 mol % or >80 mol %, or >90 mol %, or >95 mol % or >97 mol %)) of units which have been derived from ethylene monomer. This includes polyethylene homopolymers or copolymers (meaning units derived from two or more comonomers). Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single-site catalyzed Linear Low Density Polyethylene, including both linear and substantially linear low density resins (m-LLDPE); Medium Density Polyethylene (MDPE); and High Density Polyethylene (HDPE). These polyethylene materials are generally known in the art; however, the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homo-polymerized or copolymerized in autoclave or tubular reactors at pressures above 14,500 psi (100 MPa) with the use of free-radical initiators, such as peroxides (see for example U.S. Pat. No. 4,599,392, which is hereby incorporated by reference). LDPE resins typically have a density in the range of 0.916 to 0.935 g/cm³.

The term “LLDPE”, includes both resin made using the traditional Ziegler-Natta catalyst systems and chromium-based catalyst systems as well as single-site catalysts, including, but not limited to, bis-metallocene catalysts (sometimes referred to as “m-LLDPE”) and constrained geometry catalysts, and includes linear, substantially linear or heterogeneous polyethylene copolymers or homopolymers. LLDPEs contain less long chain branching than LDPEs and includes the substantially linear ethylene polymers which are further defined in U.S. Pat. Nos. 5,272,236, 5,278,272, 5,582,923 and 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The LLDPEs can be made via gas-phase, solution-phase or slurry polymerization or any combination thereof, using any type of reactor or reactor configuration known in the art.

The term “MDPE” refers to polyethylenes having densities from 0.926 to 0.935 g/cm³. “MDPE” is typically made using chromium or Ziegler-Natta catalysts or using single-site catalysts including, but not limited to, bis-metallocene catalysts and constrained geometry catalysts, and typically have a molecular weight distribution (“MWD”) greater than 2.5.

The term “HDPE” refers to polyethylenes having densities greater than about 0.935 g/cm³ and up to about 0.970 g/cm³, which are generally prepared with Ziegler-Natta catalysts, chrome catalysts or single-site catalysts including, but not limited to, bis-metallocene catalysts and constrained geometry catalysts.

The term “ULDPE” refers to polyethylenes having densities of 0.880 to 0.912 g/cm³, which are generally prepared with Ziegler-Natta catalysts, chrome catalysts, or single-site catalysts including, but not limited to, bis-metallocene catalysts and constrained geometry catalysts.

“Polyolefin plastomer” can be a polyethylene plastomer or a polypropylene plastomer. Polyolefin plastomers include, for example, polymers made using single-site catalysts such as metallocenes and constrained geometry catalysts. Polyolefin plastomers have a density of 0.885 to 0.915 grams/centimeters³ (g/cc). All individual values and subranges from 0.885 g/cc to 0.915 g/cc are included herein and disclosed herein; for example, the density of the polyolefin plastomer can be from a lower limit of 0.895, 0.900, or 0.905 g/cc to an upper limit of 0.905, 0.910, or 0.915 g/cc. In some embodiments, the polyolefin plastomer has a density from 0.890 to 0.910 g/cc.

“Polyolefin elastomer” can be a polyethylene elastomer or a polypropylene elastomer. The polyolefin elastomers have a density of 0.857 to 0.885 g/cc. All individual values and subranges from 0.857 g/cc to 0.885 g/cc are included herein and disclosed herein; for example, the density of the polyolefin elastomer can be from a lower limit of 0.857, 0.860, 0.865, 0.870, or 0.875 g/cc to an upper limit of 0.870, 0.875, 0.880, or 0.885 g/cm³. In some embodiments, the polyolefin elastomer has a density from 0.860 to 0.880 g/cc.

“Polyethylene-based film” or “PE-based film” refers to a film that comprises at least 90 weight percent of polyethylene, at least 95 weight percent of polyethylene, at least 97 weight percent of polyethylene based on the total weight of the film.

Embodiments of a laminate material comprise a first substrate comprising a first polyethylene (PE)-based film and a first metalized layer disposed on at least one surface of the first PE-based film and a second substrate comprising a second PE-based film and a second metalized layer disposed on at least one surface of the second PE-based film. The laminate material comprises an adhesive layer adhering the first substrate to the second substrate, the adhesive layer disposed between the first and second metalized layers. The laminate material has greater than 90 wt. % PE based on the total weight of the laminate material.

### First and Second Substrates

The first and second PE-based films have at least one layer comprising polyethylene. Alternatively, there can be two or more layers comprising polyethylene, which are extruded together. When there are three (or three or more) layers comprising polyethylene, the layer adjacent the metal layer is called herein a skin layer, the layer opposite the metal layer on the outside of the first and second PE-based films is called a sealant layer, and a layer or layers between the skin and sealant layers is a core layer or core layers. When there is only one layer comprising polyethylene, any of the polyethylene compositions discussed herein as skin, core or sealant layers can be used. When there are only two layers comprising polyethylene, any combinations of skin layer and core layer, skin layer and sealant layer, or core layer and sealant layer can be used. When there are two or more polyethylene-comprising layers, each polyethylene-comprising layer can be immediately adjacent to at least one other polyethylene-comprising layer, or an adhesive layer or other intermediary layer can be used between the two or more polyethylene-comprising layers.

The first and second PE-based films can comprise a linear low density polyethylene (LLDPE), medium density polyethylene (MDPE), high density polyethylene (HDPE), a low density polyethylene (LDPE) as well as combinations of two or more of the foregoing. Preferably, the PE-based film in the metalized PE-based film can comprise a Ziegler-Natta catalyzed, single site catalyzed (including, without limitation, metallocene), or Chromium catalyzed linear low density polyethylene (LLDPE), medium density polyethylene (MDPE), high density polyethylene (HDPE), an autoclave produced or tubular produced low density polyethylene (LDPE) as well as combinations of two or more of the foregoing.

The first and second PE-based films can further comprise at least one of an ultra-low density polyethylene, a polyolefin plastomer, a polyolefin elastomer, an ethylene vinyl acetate copolymer, an ethylene ethyl acrylate copolymer, an ethylene vinyl alcohol, and any polymer comprising at least 50 wt. % ethylene monomer, and combinations thereof.

A skin layer can comprise a linear low density polyethylene (LLDPE), medium density polyethylene (MDPE), high density polyethylene (HDPE), a low density polyethylene (LDPE) as well as combinations of two or more of the foregoing; preferably can comprise a linear low density polyethylene (LLDPE), a low density polyethylene (LDPE) or combinations thereof. This LLDPE can be a single site catalyzed polyethylene (such as, and without limitation, m-LLDPE). The skin layer can further comprise additives, such as, for example, antioxidants, ultraviolet light stabilizers, thermal stabilizers, slip agents, antiblock, pigments or colorants, processing aids, crosslinking catalysts, flame retardants, fillers and foaming agents. When used in combination with a core layer or sealant layer, the skin layer is the layer that is metalized and in that instance is advantageously free of slip agents but may include anti-blocking agents (e.g. talc, silicon dioxide, etc.), anti-oxidants, and processing aids. In an embodiment, the additives such as slip agents and anti-blocking agents typically will not be used in the skin layer.

A core layer can comprise a linear low density polyethylene (LLDPE), medium density polyethylene (MDPE), high density polyethylene (HDPE), a low density polyethylene (LDPE) as well as combinations of two or more of the foregoing. The core layer can preferably comprise a middle density polyethylene (MDPE), a high density polyethylene (HDPE) or combinations thereof. The core layer can also comprise additives as mentioned for the skin layer. Preferably, additives such as slip agents and anti-blocking agents typically will not be used in the core layer. This layer can be adjacent the skin layer on an opposite side of the skin layer from the metal layer.

A sealant layer can comprise a linear low density polyethylene (LLDPE), medium density polyethylene (MDPE), high density polyethylene (HDPE), a low density polyethylene (LDPE), polyolefin elastomers or plastomers, as well as combinations of two or more of the foregoing. Preferably, the sealant layer can comprise a Ziegler-Natta catalyzed, single site catalyzed (including metallocene), or Chromium catalyzed linear low density polyethylene (LLDPE), medium density polyethylene (MDPE), high density polyethylene (HDPE), an autoclave produced or tubular produced low density polyethylene (LDPE) as well as combinations of two or more of the foregoing, preferably comprise a linear low density polyethylene (LLDPE), a low density polyethylene (LDPE) or combinations thereof. The LLDPE can be a single site catalyzed polyethylene (e.g. mLLDPE). This can be an outer layer of the film.

The sealant layer may advantageously include an anti-blocking agent. An anti-blocking agent is a compound that minimizes, or prevents, blocking (i.e., adhesion) between two adjacent layers of film. Blocking can cause issues, for example, during unwinding of a film roll. The use of antiblock agents is well known to persons of ordinary skill in the art. Examples of common antiblock agents include, without limitation, silica, talc, calcium carbonate, and combinations thereof.

In one embodiment, an anti-blocking agent may be present in the sealant layer at an amount of at least about 200 ppm, at least about 1000 ppm or at least about 1500 ppm, preferably not greater than about 6000 ppm, or not greater than about 5000 ppm.

In addition, slip agents (e.g., erucamide) may be helpful. A slip agent is a compound added to a film to reduce friction between films and/or between films and equipment. Typical slip agents include migratory and non-migratory slip agents and are well to persons of ordinary skill in the art. For example, slip agents may be present in the sealant layer at an amount of less than 500 ppm, or less than 300 ppm, or less than 200 ppm, less than 100 ppm, preferably less than 50 ppm, or equal to 0 ppm, based on total weight of the sealant layer.

The first and second PE-based films can be blown films, cast films, machine direction oriented films or biaxially oriented films. The first and second PE-based films can be fabricated through blown, casting, water quenching, double bubble, or other techniques known to those of ordinary skill in the art such as those described in Film Processing Advances, Toshitaka Kanai and Gregory A. Campbell (editors), Chapter 7 (Biaxial Oriented Film Technology), pp. 194-229. In some embodiments, after fabrication, the film may be subjected to machine direction orientation (MDO) or biaxial orientation process to provide a machine direction oriented film or a biaxially oriented film, respectively.

The first and second metalized layers can be metalized by any known method for metallizing polyethylene films. For example, the first and second metalized layers can be applied using vacuum metallization. This can include providing a metal source and evaporating it in a vacuum environment causing it to condense on the surface of the film. The first and second metalized layers may be deposited on the skin layer of the first and second PE-based films. The metal of the first metalized layer or the second metalized layer independently include Al, Zn, Au, Ag, Cu, Ni, Cr, Ge, Se, Ti, Sn, or oxides thereof. The first and second metalized layers can be formed from aluminum or aluminum oxide (Al₂O₃) in some embodiments.

The overall thickness of the first and second substrates may be at least 10, at least 20, or at least 30 microns. The overall thickness of the first and second substrates according to certain embodiments is no more than 200, no more than 150, no more than 120, no more than 100, no more than 80, no more than 70, or no more than 60 microns.

The first and second substrates may have an optical density (OD) at least 1.5, or at least 1.8 and no more than 4.0, no more than 3.5, or no more than 3.0. In some embodiments, the OD is 2.0. The optical density (e.g., a multilayer structure comprising a polyethylene film with a metal layer deposited on it) can be measured using an optical density meter (Model No. LS177 from Shenzhen Linshang Technology).

The first and second substrates may retain a surface energy of the metallized surface of at least 34 dyne/cm, at least 38 dyne/cm, at least 40 dyne/cm, or at least 42 dyne/cm, or at least 46 dyne/cm for at least one or at least two weeks from the metallization.

The first and second substrates may be characterized by the absence (0 ppm) or substantial absence of fatty acids or its derivatives. Such fatty acids or its derivatives that are absent or substantially absent include saturated fatty acid with an even number of carbon atoms, from 4 to 28, such as strearic acid (18 carbon atoms) and palmitic acid (16 carbon atoms), etc., and the metal salts of the respective fatty acid, such as calcium stearate, zinc stearate, calcium palmitate, etc. Specifically, the concentration of fatty acids or its derivatives in the metalized PE-based film can be no more than 300 ppm, no more than 300 ppm, no more than 200 ppm, no more than 100 ppm, or no more than 50 ppm, or equal to 0 ppm, based on total weight of the metalized PE-based film.

Additional additives may also be included in the first or second PE-based films. One example is an anti-oxidant, which is included in polymeric films to stabilize the polymer(s) or prevent oxidative degradation of the polymer(s). The concentration of anti-oxidants in the first and/or second substrates may be less than 3000 ppm, or less than 2000 ppm, or less than 1500 ppm, or less than 1300 ppm, based on the total weight of the first and/or second substrates. Without being limited by theory,

### Adhesive Layer

Various adhesives are considered suitable for the adhesive layer. In one or more embodiments, the adhesive layer may comprise solvent-based adhesive, solventless adhesive, or water-based adhesive. In one or more embodiments, the adhesive layer achieves an adhesive bonding strength of at least 4 N/15 mm, at least 6 N/15 mm, or at least 8 N/15 mm. Without being limited by theory, suitable adhesives when disposed between the first and second metalized layers may synergistically achieve an OTR of less than 1.0 cc/m²*24 hours as measured under the condition of 23° C. and 0% relative humidity when measured using the Test Method.

Various compositions are considered suitable for the adhesive. In one embodiment, the adhesive layer may be derived from a two-component solvent-based polyurethane adhesive composition, the two-component solvent-based polyurethane adhesive composition comprises a polyester polyol component and a polyisocyanate component. The polyester polyol component comprises 40 wt. % to 60 wt. % aromatics based on the total dry weight of the polyester polyol, and the polyester polyol component comprises a weight average molecular weight (Mw) between 5,000 and 50,000 g/mol; and a weight ratio of the polyester polyol component to the polyisocyanate component is from 100:5 to 100:30, or from 100:10 to 100:20.

The adhesive layer is derived from a two-component solvent-based polyurethane adhesive composition, wherein the two-component solvent-based polyurethane adhesive composition comprises a polyester polyol component and a polyisocyanate component.

According to an embodiment of the present disclosure, the adhesive composition is a “two-component” or “two-part” composition comprising a polyester polyol component and a polyisocyanate component. According to another embodiment, the polyester polyol component and the polyisocyanate component are packaged, transported and stored separately, combined shortly or immediately before being used for the manufacture of the laminate material.

The polyester polyol is typically obtained by reacting polyfunctional alcohols having from 2 to 12 carbon atoms, preferably from 2 to 10 carbon atoms, with polyfunctional carboxylic acids having from 2 to 12 carbon atoms, preferably 2 to 10 carbon atoms, or anhydrides/esters thereof. Typical polyfunctional alcohols for preparing the polyester polyol are preferably diols, triols, tetraols, and may include ethylene glycol, butylene glycol, diethylene glycol, triethylene glycol, polyalkylene glycols, 1,2-propanediol, 1,3-propanediol, 1,3-butanediol, 1,4-butanediol, 1,6-hexanediol, neopentyl glycol, trimethylolpropane, glycerol, erythritol, pentaerythritol, trimethylolbenzene, and any combinations thereof. Typical polyfunctional carboxylic acids for preparing the polyester polyol can be aliphatic, cycloaliphatic, araliphatic, aromatic or heterocyclic and may be substituted, for example with halogen atoms, and/or may be saturated or unsaturated. Preferably, the polyfunctional carboxylic acids are selected from the group consisting of adipic acid, suberic acid, azelaic acid, sebacic acid, phthalic acid, isophthalic acid, glutaric acid, tetrachlorophthalic acid, maleic acid, fumaric acid, itaconic acid, malonic acid, 2-methyl succinic acid, 3,3-diethyl glutaric acid, 2,2-dimethyl succinic acid, trimellitic acid, the anhydrides thereof, and any combinations thereof. Preference is given to adipic acid or a mixture of adipic acid and isophthalic acid. In another embodiment, the polyester polyol has an OH number of 2 to 30 mg KOH/g, preferably from 5 to 25 mg KOH/g, and more preferably from 8 to 20 mg KOH/g.

According to an embodiment of the present disclosure, the polyester polyol has a hydroxyl functionality of at least 1.8, or at least 1.9, or at least 2.0, or at least 2.1, or at least 2.2, or up to 2.3, or up to 2.4, or up to 2.5, or up to 2.6, or up to 2.7, or up to 2.8, or up to 2.9, or up to 3.0, or within a numerical range obtained by combining any two of the above indicated end points. The polyester polyol may have a molecular weight from 5000 to 50,000 g/mol, or from 5500 to 30,000 g/mol, or from 6,000 to 25,000 g/mol, or from 10,000 to 15,000 g/mol, or within a numerical range obtained by combining any two of the above indicated end points. The above introduction about the origin, preparation process, category, molecular structure and various parameters of polyester polyol also apply to this second polyester polyol.

According to an embodiment of the present disclosure, the polyester polyol has an aromatic ring content of from about 40 wt. % to about 60 wt. % or from about 45 wt. % to about 55 wt. % or from about 47 wt. % to about 55 wt. %, based on the dry weight of the polyester polyol.

The solid content of polyester polyol component can be 40-85 wt. %, preferably 50-80 wt. %, more preferably 55-75 wt. %, and the solvent used for the polyester polyol could be ethyl acetate or MEK, or combination, preferably ethyl acetate.

The polyisocyanate may include any molecules having 2 or more isocyanate groups, and mixtures thereof. Such polyisocyanates can be aliphatic, alicyclic, aromatic, araliphatic or mixtures thereof. The polyisocyanates may have an average functionality of >2 or from 2.5 to 10. Examples of suitable polyisocyanates include C₂-C₁₂ aliphatic diisocyanates, as well as dimers and trimers thereof, such as, for example, C₂-C₈ alkylene diisocyanates, such as tetramethylene diisocyanate and hexamethylene diisocyanate (HDI), 1,12-dodecane diisocyanate, 2,2,4-trimethyl-hexamethylene diisocyanate, 2,4,4-trimethyl-hexamethylene diisocyanate, 2-methyl-1,5-pentamethylene diisocyanate; C₆-C₁₅ alicyclic diisocyanates, as well as dimers and trimers thereof, such as, for example, isophorone diisocyanate (IPDI) and dicyclohexyl methane diisocyanate (HMDI), 1,4-cyclohexane diisocyanate, and 1,3-bis-(isocyanatomethyl)cyclohexane; C₆-C₁₂ aromatic diisocyanates, as well as dimers and trimers thereof, such as, for example, toluene diisocyanate (TDI), and diphenyl methane diisocyanate (MDI); C₇-C₁₅ araliphatic diisocyanates as well as dimers and trimers thereof, such as, for example,

Preferably, the polyisocyanate comprises aliphatic or aromatic polyisocyanates. More preferably, the polyisocyanates are hexamethylene diisocyanate homopolymers, hexamethylene diisocyanate adducts, isophorone diisocyanate homopolymers, isophorone diisocyanate adducts, toluene diisocyanate (TDI), toluene diisocyanate (TDI) adducts, diphenyl methane diisocyanate (MDI), diphenyl methane diisocyanate (MDI) adducts, or mixtures thereof. The trimers (or isocyanurates) in the polyisocyanate may be prepared by methods known in the art, for example, as disclosed in U.S. Patent Publication No. 2006/0155095A1, to Daussin et al., by trimerizing an alicyclic diisocyanate (e.g. isophorone diisocyanate) in the presence of one or more trimerization catalyst, such as, for example, a tertiary amine or phosphine or a heterogeneous catalyst, and, if desired, in the presence of solvents and/or assistants, such as co-catalysts, expediently at elevated temperature, until the desired isocyanate (NCO) content has been reached, and then deactivating the catalyst using inorganic and organic acids, the corresponding acid-halides and alkylating agents and, preferably, heating. Isocyanurate compositions containing isocyanurates from aliphatic diisocyanates may likewise be formed by cyclizing aliphatic diisocyanates in the presence of one or more trimerization catalyst and then deactivating the catalyst. Any of the isocyanurates can be further modified by conventional methods to contain urethane, urea, imino-s-triazine, uretonimine or carbodiimide moieties. Preferably, the polyisocyanate useful in the present disclosure is selected from the group consisting of an aromatic diisocyanate, dimers and trimers thereof, or mixtures thereof.

The polyisocyanate useful in the present disclosure may include one or more polyisocyanate prepolymers, which may be formed by reaction of a diisocyanate with a monol, diol, diamine, or monoamine, which is then modified by the reaction of additional isocyanate to form allophanate or biuret modified prepolymers. Such prepolymers may further comprise a polyalkoxy or polyether chain. Alternatively, such prepolymers can then be mixed with a trimerization catalyst giving an allophanate or biuret modified polyisocyanate compositions. Preparation of such allophanate or biuret prepolymers, followed by trimerization, is known in the art, see for example, U.S. Pat. Nos. 5,663,272 and 6,028,158. Still further, suitable polyisocyanates may be modified by an ionic compound such as aminosulfonic acid.

Commercially available polyisocyanates may include, for example, Desmodur L75, N3300, N3600, and N3900 polyisocyanates and Bayhydur XP 2655, 401-60 and 401-70 polyisocyanates (Covestro); Tolonate HDT, HDT-LV and HDT-LV2, and Easaqua L 600 polyisocyanates (Vencorex Chemicals); DURANATE TLA-100 and TMA-100 polyisocyanates (AsahiKASEI); and Aquolin 268, 269 and 270 polyisocyanates (Wanhua Chemicals).

The polyisocyanate useful in the present disclosure can be used directly or diluted with one or more solvents to form a polyisocyanate solution, prior to mixing with the polyol component. Such solvents (also as “diluting solvents”) can reduce the viscosity of the polyisocyanate and have no reactivity with the polyisocyanate. The solvent may be used in an amount of from 5% to 150%, from 15% to 130%, from 20% to 120%, or from 30% to 100%, by weight based on the weight of the polyisocyanate. Suitable diluting solvents may include, for example, ethyl acetate, butyl acetate, MEK, or mixtures thereof. The solid content of the polyisocyanate component can be 40-100 wt. %, preferably 50-90 wt. %, more preferably 55-80 wt. %. The polyurethane adhesive composition of the present disclosure may have equivalent ratios of the total number of isocyanate group equivalents in the polyisocyanates, which may contain several different polyisocyanates, to the total number of hydroxyl group equivalents in the polyester polyol component, in the range of, for example, from 1:1 to 2.0:1, or from 1:1 to 1.8:1, or from 1:1 to 1.5:1 or 1:1 to 1.2:1. According to a preferable embodiment of the present disclosure, the amount of the polyisocyanate compound is properly selected so that the isocyanate group is present at a stoichiometric molar amount relative to the total molar amount of the hydroxyl groups included in the polyester polyol component.

The polyurethane adhesive composition of the present disclosure may further comprise conventional additives such as, for example, catalysts to enhance curing, pigments, light stabilizers, ultraviolet (UV) absorbing compounds, leveling agents, wetting agents, dispersants, neutralizers, defoamers, or rheology modifiers, or mixtures thereof. These additives may be present in an amount of from zero to 20%, from 1 to 10%, by weight based on the weight of the polyurethane composition.

According to an embodiment of the present disclosure, the weight ratio of the polyester polyol component to the polyisocyanate component is from about 100:5 to about 100:30, preferably from about 100:8 to about 100:25, more preferably from about 100:10 to about 100:20.

The polyurethane adhesive can be prepared by mixing polyester polyol component and polyisocyanate component together to mix them homogeneously and adding a certain amount of solvent to achieve a desired solid content.

### Laminate Material

The content of PE in the laminate material is greater than 90 wt. %, or greater than 92 wt. %, greater than 93 wt. %, greater than 95 wt. %, greater than 98 wt. %, based on the total weight of the laminate material.

The laminate of the present disclosure may have an OTR of lower than 1.0 cc/m²*24 hours measured under the condition of 23 °C. and 0% relative humidity when measured using the Test Method described herein, or 0.5 cc/m²*24 hours or less when measured using the Test Method described herein. Without being limited by theory, adhering the first and second metalized layers to join the first and second substrates provides a significant decrease in OTR as well as improved adhesive strength.

While the discussion of laminates focus on adhering first and second substrates having over 90 wt. % polyethylene, it is also contemplated to have additional films laminated to the laminates of the first and second substrates. In one embodiment, an oriented PE film, for example, a biaxially oriented polyethylene film may be adhered to the first substrate, the second substrate or both.

The laminate material can be used to form articles such as packages. Examples of packages that can be formed from the laminate material of the present disclosure can include flexible packages, pouches, stand-up pouches, and pre-made packages or pouches. The laminate material of the present disclosure can be used for food packages. Examples of food that can be included in such packages include meats, cheeses, cereal, nuts, juices, sauces, and others. Such packages can be formed using techniques known to those of skill in the art based on the teachings herein and based on the particular use for the package (e.g., type of food, amount of food, etc.).

### Test Methods

### Density

Unless indicated otherwise, all densities were measured according to ASTM D792-08, Method B.

### Melt Index (I₂)

Unless indicated otherwise, all melt indices (2) were measured according to ASTM D1238-10, Method B, at 190 °C and a 2.16 kg load, and are reported in decigrams per minute (dg/min).

### Oxygen Transmission Rate (OTR)

The OTR was measured in accordance with ASTM D-3985 using a MOCON OX-TRAN Model 2/21 measurement device at a temperature of 23 °C at a relative humidity of 0% using purified oxygen.

### Adhesive Bonding Strength

The test is performed using Dow Internal Method at INSTRON 5965 at a test speed=250 mm/min and a temperature of 25 °C (peel mode: T-peel, sample width: 15 mm).

### Examples

Some embodiments of the invention will now be described in the following Examples. However, the scope of the present disclosure is not, of course, limited to the formulations set forth in these examples. Rather, the Examples are merely inventive of the disclosure.

TABLE 1
Materials Used

| | Product Name | Composition | Remark | Supplier |
|---|---|---|---|---|
| Adhesives | ADCOTE ™ | 100ER: Polyester polyol, | Solvent- | Dow ™ Inc. |
| | 100ER/COREACTANT F | aromatic ring = 47% | based (SB) | |
| | | Mw = 14288, | Polyurethane | |
| | | 66%, solid content; | adhesive | |
| | | COREACTANT F: | | |
| | | Polyisocyanate, 75% solid | | |
| | | content. | | |
| | ROBOND ™ L-95D | Acrylic adhesive | Water Based | Dow ™ Inc. |
| | | | Acrylic | |
| | | | adhesive | |
| PE products | ELITE ™ AT6410 | MI = 0.85, Density = 0.912 | LLDPE | Dow ™ Inc. |
| | ELITE ™ AT6900 | MI = 1.2, Density = 0.969 | HDPE | Dow ™ Inc. |
| | XUS61800.28 | MI = 0.8, Density = 0.961 | HDPE | Dow ™ Inc. |
| | DOW ™ LDPE 450E | MI = 2.0, Density = 0.923 | LDPE | Dow ™ Inc. |
| Anti- | AB-20LD masterbatch | MI = 1.9, Density 0.925 | | Beijing |
| blocking | | | | Yalunzhilian |
| agent | | | | Science & |
| | | | | Technology |
| | | | | Co., Ltd |

TABLE 2
PE-based films

| PE based | | | | | | Additives |
|---|---|---|---|---|---|---|
| Film | Layer | | | | | Concentration |
| name | Ratio | Thickness | Skin Layer | Core Layer | Sealant Layer | (ppm) |
| Film 1 | 1/3/1 | 60 μm | 90 wt. % | 91 wt. % XUS | 88 wt. % | Anti-oxidant: |
| | | | ELITE ™ | 61800.28 + 9 | ELITE ™ | 871 |
| | | | AT6410 + | wt. % LDPE | AT6410 + | Antiblock in the |
| | | | 10 wt. % LDPE | 450E | 10 wt. % LDPE | sealant layer: |
| | | | 450E | | 450E + | 4000 |
| | | | | | 2 wt. % AB20L | Slip agent in the |
| | | | | | | sealant layer: 0 |
| | | | | | | Fatty acid or its |
| | | | | | | derivatives: 0 |

Referring to Table 2, PE-based Film 1 was fabricated through a blown film process. The vacuum metallization was conducted onto the skin layer of PE-based film 1, with an industrial metallization machine (Machine type K5 EXPERT, BOBST Company) with OD=2.0. As shown in Table 3, MET 1 is the symbol reflecting the metalized version of PE-based Film 1, respectively. First, the adhesive lamination underwent drawdown on K-coater (model 101, R K Print-Coat Instruments Ltd.) to achieve 3.5 gsm coating weight. The adhesive layer was disposed between the first and second metalized layers. Next, the hand lamination (Hot Roll Laminator, HR-101, Chem-Instruments Ltd.) was performed with pressure of 40 psi and nip temperature of 150 F.

TABLE 3

| Laminate | First | Second | |
|---|---|---|---|
| name | Substrate | Substrate | Adhesive |
| Inventive | MET 1 | MET 1 | ADCOTE ™ 100ER/ |
| example 1 | | | COREACTANT F |
| Comparative | MET 1 | MET 1 | ROBOND ™ L-95D |
| Example 1 | | | |
| Comparative | MET 1 | N/A | No adhesive, single-ply metallized |
| Example 2 | | | Film-1 without lamination |

TABLE 4
Laminates

| | OTR (cc/m²-day, | Adhesive Bonding |
|---|---|---|
| Laminate name | 23° C., 0% RH) | Strength (N/15 mm) |
| Inventive example 1 | 0.5 | 6.0 |
| Comparative example 1 | 28.95 | 2.6 |
| Comparative example 2 | 47.1 | N/A |

Referring to Table 4, Comparative example 2 is a single ply MET 1 film without lamination. The OTR is measured of 47.1 cc/m²-day. Comparative example 1 is a laminate including two ply MET 1 films bonded by the acrylic adhesive L95D. The OTR is about 29 cc/m²-day, which is close to half of the single-ply MET 1, and the bonding strength is about 2.6 N/15 mm. Inventive Example 1 is a laminate including two ply MET 1 films bonded together by the polyurethane adhesive 100ER/F. The OTR can be drastically decreased to 0.5 cc/m²-day, which is significantly lower than half OTR of comparative example 1 and 2. In addition, the adhesive bonding strength of 6 N/15 mm, which is much higher than acrylic adhesive laminate (Comparative Example 1), can promise much safer protection during the storage, transportation, etc.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 g/cm³” is intended to mean “about 40 g/cm³.”

Notations used in the equations included herein refer to their standard meaning as understood in the field of mathematics. For example, “=” means equal to, “x” denotes the multiplication operation, “+” denotes the addition operation, “−” denotes the subtraction operation, “>” is a “greater than” sign, “<” is a “less than” sign, “and “/” denotes the division operation.

Every document cited herein, if any, including any cross-referenced or related patent or patent application and any patent or patent application to which this application claims priority or benefit thereof, is hereby incorporated herein by reference in its entirety unless expressly excluded or otherwise limited. The citation of any document is not an admission that it is prior art with respect to any embodiment disclosed or claimed herein or that it alone, or in any combination with any other reference or references, teaches, suggests or discloses any such embodiment. Further, to the extent that any meaning or definition of a term in this document conflicts with any meaning or definition of the same term in a document incorporated by reference, the meaning or definition assigned to that term in this document shall govern.

1. A laminate material comprising:
a first substrate comprising a first polyethylene (PE)-based film and a first metallized layer disposed on at least one surface of the first PE-based film;
a second substrate comprising a second PE-based film and a second metallized layer disposed on at least one surface of the second PE-based film; and
an adhesive layer adhering the first substrate to the second substrate, the adhesive layer disposed between the first and second metallized layers,
wherein the laminate material has greater than 90 wt. % PE based on the total weight of the laminate material.

2. The laminate material of claim 1, wherein the adhesive layer comprises solvent-based adhesive, solventless adhesive, or water-based adhesive.

3. The laminate material of claim 1, wherein the adhesive layer is derived from a two-component polyurethane adhesive composition, the two-component polyurethane adhesive composition comprises a polyester polyol component and a polyisocyanate component.

4. The laminate material of claim 3, wherein the polyester polyol component comprises 40 wt. % to 60 wt. % aromatic rings based on the total dry weight of the polyester polyol, and the polyester polyol component comprises a weight average molecular weight (Mw) between 5,000 and 50,000 g/mol; and a weight ratio of the polyester polyol component to the polyisocyanate component is from 100:5 to 100:30, or from 100:10 to 100:20.

5. The laminate material of claim 1, wherein the concentration of fatty acids or fatty acid derivatives in the first substrate is less than 500 ppm based on the total weight of the first substrate, and the concentration of fatty acids or fatty acid derivatives in the second substrate is less than 500 ppm based on the total weight of the second substrate.

6. The laminate material of claim 1, wherein the first and second PE-based films comprise high density polyethylene (HDPE), linear low density polyethylene (LLDPE), low density polyethylene (LDPE), or combinations thereof.

7. The laminate material of claim 1, wherein the first and second PE-based films each comprise a skin layer, a core layer and a sealant layer.

8. The laminate material of claim 7, wherein anti-blocking agents are present in the sealant layer at an amount of at least 200 ppm, based on total weight of the sealant layer.

9. The laminate material of claim 1, wherein the metal of the first metallized layer or the second metallized layer independently include Al, Zn, Au, Ag, Cu, Ni, Cr, Ge, Se, Ti, Sn, or oxides thereof.

10. The laminate material of claim 1, wherein the concentration of anti-oxidants in the first substrate, the second substrate, or both is less than 3000 ppm based on the total weight of the first substrate, the second substrate, or both.

11. The laminate material of claim 1, wherein the first PE-based film, the second PE-based film, or both are blown films, cast films, machine direction oriented films, or biaxially oriented films.

12. The laminate material of claim 1, wherein the laminate material has greater than 95 wt. % PE based on the total weight of the laminate material.

13. An article comprising the laminate material of claim 1.

14. A method for preparing the laminate material of claim 1, comprising adhering the first substrate to the second substrate together by using the two-component polyurethane adhesive composition.
